(19) United States
(12) Patent Application Publication
(10) Pub. No.: US 2010/0137513 A1
(43) Pub. Date: Jun. 3, 2010

(54) Process for Preparation of Composite Containing Wood Fiber Component and Polymer Resin

(76) Inventors: Yousoo Han, Daejeon (KR); Seongchan Park, Chungcheongbuk-do (KR); Jungil Son, Gyeonggi-do (KR); Dongjin Kim, Daejeon (KR); Sangho Han, Chungcheongbuk-do (KR); Yunhwan Hwang, Seoul (KR); Jaewook Lee, Seoul (KR)

Correspondence Address: MCKENNA LONG & ALDRIDGE LLP, 1900 K STREET, NW, WASHINGTON, DC, 20006, US

(21) Appl. No.: 11/922,095

(22) PCT Filed: Aug. 17, 2006
(86) PCT No.: PCT/KR2006/003217

§ 371 Date: May 5, 2009

(30) Foreign Application Priority Data
Aug. 18, 2005 (KR) 10-2005-0075709

(51) Int. Cl. C08F 251/02; C08F 2/00; B29C 47/00

(52) U.S. Cl. 525/54.21; 204/157.68; 264/442

(57) ABSTRACT

Provided is a process for preparing a wood fiber-polymer composite containing a wood fiber component and a polymer resin, comprising inducing chemical bonding reaction between the wood fiber and polymer by application of an ultrasonic wave upon contact of the wood fiber component with the molten polymer resin. The process of the present invention enables production of a composite having superior mechanical, thermal and Theological processing properties, by induction of chemical bonding between the wood fiber and polymer resin even without use of additional additives. Consequently, the present invention provides advantages such as reduction of composite production costs, no need to select and change kinds of additives corresponding to components of the composite and thereby high flexibility of manufacturing process.

### FIELD OF THE INVENTION

The present invention relates to a process for preparing a composite containing a wood fiber component and a polymer resin. More specifically, the present invention relates to a process for preparing a composite having superior mechanical/thermal properties and rheological processability characteristics even without use of additional additives such as binders, by induction of chemical bonding reaction between a wood fiber and a polymer via application of an ultrasonic wave during a mixing and/or extrusion process of the wood fiber and molten polymer.

### BACKGROUND OF THE INVENTION

As is generally known, natural wood is expensive and is vulnerable to morphological and structural deformation or surface damage upon exposure to various external environmental factors such as water and sunlight. On the other hand, synthetic resins such as polymers are inexpensive and highly durable, but have shortcomings such as surface texture of undesirable oily tactile feel intrinsic to plastic resins, a generally undesirable external appearance including poor color characteristics, and low strength depending upon kinds of materials. As an attempt to enhance the strength of the polymer resin, composite materials designed by addition of a granular or linear filler to the polymer resin have been developed and used.

Specifically, composite materials have been developed which exhibit wood's natural appearance and texture while enhancing the strength by adding to the polymer resin a wood fiber component such as wood flour, as a filler.

However, wood fiber components, which are based on the cellulose molecular structure, exhibit hydrophylicity, while the polymer resins generally exhibit hydrophobic nature. These different physical properties lead to low interfacial bonding strength between the wood fiber component and polymer resin, and as a result, there is a difficulty to impart the desired degree of strength to the resulting composite products. Further, such composite materials also suffer from disadvantages such as poor thermal, mechanical and rheological properties including moisture-induced deformation.

Therefore, as an effort to increase the interfacial adhesion strength between the wood fiber component and polymer resin, a technique has been developed which involves induction of the bonding between the molecular chain of the wood fiber and the molecular chain of the polymer, via separate addition of certain compounds such as maleic anhydride and the like.

Even though the use of such additives may solve some problems as discussed above, separate addition of expensive compounds during mixing of the wood fiber component and polymer resin results in various problems such as increased production costs of the composite and replacement of additives with appropriate ones corresponding to kinds of polymer resins.

As such, there is a strong need for the development of a technique which is capable of preparing a wood fiber-polymer composite at a low production cost and is further capable of preparing a desired composite irrespective of kinds of polymer resins.

### SUMMARY OF THE INVENTION

As a result of a variety of extensive and intensive studies and experiments to solve the problems as described above, the inventors of the present invention have discovered that, during a mixing, extrusion or injection process of a wood fiber component and a polymer resin, application of an ultrasonic wave leads to increases in dispersibility of respective components and surprisingly also leads to cross-linking between molecular chains by the action of radicals formed from partial cleavage of molecular chains, thereby forming a composite having enhanced bonding strength between the wood fiber component and polymer resin. The present invention has been completed based on these findings.

Therefore, the present invention has been made in view of the above problems, and it is an object of the present invention to provide a process for preparing a synthetic resin composite containing a wood fiber.

It is another object of the present invention to provide a wood fiber-polymer composite prepared using the above-mentioned process.

### DETAILED DESCRIPTION OF PREFERRED EMBODIMENTS

In accordance with an aspect of the present invention, the above and other objects can be accomplished by the provision of a process for preparing a synthetic resin composite containing a wood fiber component and a polymer resin, comprising inducing chemical bonding reaction between the wood fiber and polymer by application of an ultrasonic wave upon contact of the wood fiber component with the molten polymer resin.

That is, the process of the present invention enables preparation of a wood fiber-polymer composite having superior mechanical, thermal and rheological processing properties by a simple method of applying an ultrasonic wave even without use of additional additives. As a result, the process of the present invention can attain reduction of composite production costs due to no use of expensive additives and features very high process flexibility due to wide applicability thereof regardless of kinds of polymer resins.

As sometimes used herein, the term “wood fiber-polymer composite” refers to a composite containing a wood fiber component and a polymer resin as a main component. Therefore, the wood fiber-polymer composite of the present invention may further include other components depending upon desired purposes and applications. In addition, the matrix component of the wood fiber-polymer composite may be a wood fiber component or otherwise may be a polymer resin. For example, the former case may be a structure in which the polymer resin was impregnated in the wood fiber component, whereas the latter case may be a structure in which the wood fiber component as a filler was added to the polymer resin. Preferably, the above composite is formed of a structure in which the wood fiber component as the filler was added to the polymer resin as the matrix component.

There is no particular limitation to the wood fiber components that can be used in the present invention, so long as they are fibrous materials having a cellulose molecular structure. Examples of the wood fiber components may include wood flour, which was processed by grinding of natural wood materials or recycled pulp into small particles, and other plant-derived natural fibers such as Hemp, Flax, Jute, Kenaf, cellulose and the like. Therefore, the wood flour-polymer composite may be used as synthetic wood for substituting natural wood. When the polymer resin is the matrix component of the composite, the wood flour has a size of preferably 10 to 200 mesh, more preferably 30 to 150 mesh, even though the size of the wood flour may vary depending upon intended applications. If the size of the wood flour is excessively large, this may lead to various disadvantages such as poor bonding strength between the wood flour due to a decreased content of the polymer resin, and a very high-roughness surface of products made of such a composite. On the other hand, if the size of the wood flour is excessively small, it is disadvantageously difficult to achieve sufficient dispersion. Examples of the wood flour may include wood flour of coniferous trees, wood flour of broadleaf trees and the like. Preferably, the wood flour is wood flour of coniferous trees such as pine, maple and the like.

There is no particular limitation to kinds of the polymer resins that can be used in the present invention, and therefore various resin materials such as thermoplastic resins, thermosetting resins and resin blends may be used. Preferably, the thermoplastic resins are used. In order to ultimately form a composite of the polymer resin with the wood fiber component, the polymer resin should be capable of maintaining a liquid-phase state during the manufacturing process of the composite. Therefore, when the thermoplastic resin is used as the polymer resin, it is preferred to use the polymer having a melting point of 100 to 250° C. at which the wood fiber component will not undergo decomposition or burning.

According to the present invention as discussed hereinbefore, an ultrasonic wave is applied when there is contact between two components, i.e., the wood fiber component and polymer resin. For example, the contact of two components may take place during mixing, extrusion and/or injection processes thereof. Application of the ultrasonic wave may be carried out in any step of such contact processes. Preferably, the polymer resin is melted in the temperature range at which the wood fiber component does not undergo decomposition or burning, and then the ultrasonic wave may be applied upon mixing of the wood flour with the molten polymer resin.

The frequency and amplitude of the applied ultrasonic wave are determined within the range in which radicals are formed by partially cleaving molecular chains of either or both of the wood fiber and polymer, and therefore may vary, for example, depending upon the molecular structure of the polymer to be used. Hence, the ultrasonic wave specified by the present invention may have a frequency of from several Hz to several tens of kHz and an amplitude of from several μm to several tens of μm.

Even though ultrasonic application may be carried out only once upon contact of the wood fiber component with the polymer resin, the ultrasonic wave may be preferably applied several times at periodic or non-periodic intervals so as to enhance the efficiency of chemical bonding between the wood fiber component and polymer resin.

The application of the ultrasonic wave is dependent upon the unique structural configuration of the apparatus for preparing a composite of interest and application time points. For example, extrusion equipment using a composite as a raw material generally includes a mixing unit, an extrusion unit, a withdrawing unit, a cutting unit and the like, and the mixing unit and/or the extrusion unit are provided with a heating device. Since mixing of components constituting the composite takes place in the mixing unit and/or the extrusion unit, an ultrasonic wave application unit may be optionally added thereto. Preferably, the ultrasonic wave application unit includes a control unit which is capable of modulating the frequency and amplitude of the ultrasonic wave. The ultrasonic wave application unit may be mounted externally and/or internally of the mixing unit and/or the extrusion unit.

As such, the ultrasonic wave application units in various forms may be added to the relevant system, as long as they have a structure capable of applying the ultrasonic wave so as to enhance the bonding strength between components upon contact of the wood fiber component with the polymer resin, based on the fundamental principle of the present invention. Therefore, it should be understood that such various forms of the ultrasonic wave application units fall within the scope of the present invention.

In accordance with another aspect of the present invention, there is provided a wood fiber-polymer composite prepared using the above-mentioned process.

Owing to the preparation process as detailed above, the wood fiber-polymer composite of the present invention is characterized in that a direct chemical bonding is formed between molecules of the wood fiber and polymer through no additional compounds (additives). Such a chemical bonding is not necessarily achieved in all of the molecular chains, and therefore a composite having desired physical properties may also be obtained by partial bonding between some parts of molecular chains.

Such a wood fiber-polymer composite may be formed into a synthetic wood board using a conventional extrusion process known in the related art, and the resulting synthetic wood board is inexpensive and exhibits superior mechanical, thermal and rheological processing properties, as compared to conventional synthetic wood boards.

### INDUSTRIAL APPLICABILITY

As apparent from the above description, a process for preparing a synthetic resin composite containing a wood fiber according to the present invention enables production of a composite having superior mechanical, thermal and rheological processing properties, by induction of chemical bonding between a wood fiber component and a polymer resin even without use of additional additives. Consequently, the present invention provides advantages such as reduction of composite production costs, no need to select and change kinds of additives corresponding to components of the composite and thereby high flexibility of a manufacturing process.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A process for preparing a wood fiber-polymer composite containing a wood fiber component and a polymer resin, comprising inducing chemical bonding reaction between the wood fiber and polymer by application of an ultrasonic wave upon contact of the wood fiber component with the molten polymer resin.

2. The process according to claim 1, wherein the wood fiber component is wood flour having a size of 10 to 200 mesh.

3. The process according to claim 1, wherein the polymer resin is a thermoplastic resin.

4. The process according to claim 3, wherein the polymer resin is a polymer having a melting point of 100 to 250° C. at which the wood fiber component does not undergo decomposition or burning.

5. The process according to claim 1, wherein contact of the wood fiber component with the polymer resin takes place during mixing, extrusion and/or injection processes.

6. The process according to claim 1, wherein the polymer resin is melted in the temperature range at which the wood fiber component does not undergo decomposition or burning, and the ultrasonic wave is then applied upon mixing of the wood fiber component with the molten polymer resin.

7. The process according to claim 1, wherein the ultrasonic wave has a frequency of from several Hz to several tens of kHz and an amplitude of from several μm to several tens of μm.

8. The process according to claim 1, wherein the ultrasonic wave is applied once or is applied several times at periodic or non-periodic intervals, upon contact of the wood fiber component with the polymer resin.

9. The process according to claim 1, wherein, in extrusion equipment including a mixing unit, an extrusion unit, a withdrawing unit and a cutting unit, the ultrasonic wave is applied to the mixing unit and/or the extrusion unit.

10. The process according to claim 9, wherein the ultrasonic wave application unit includes a control unit which is capable of modulating the frequency and amplitude of the ultrasonic wave, and is mounted externally and/or internally of the mixing unit and/or the extrusion unit.

11. A wood fiber-polymer composite prepared using the process of any one of claims 1 to 10.

12. The composite according to claim 11, wherein the composite is synthetic wood prepared by an extrusion process.
